(19) United States
(12) Patent Application Publication
(10) Pub. No.: US 2008/0154500 A1
(43) Pub. Date: Jun. 26, 2008

(54) Personal navigation device

(75) Inventor: Ha-Chun Chien, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTek COMPUTER INC.

(21) Appl. No.: 12/003,446

(22) Filed: Dec. 26, 2007

(30) Foreign Application Priority Data
Dec. 25, 2006 (TW) 095148817

(51) Int. Cl. G01C 21/36

(52) U.S. Cl. 701/211; 701/208

(57) ABSTRACT

A Personal Navigation Device (PND) includes a Global Positioning System (GPS) module for generating a plurality of sets of coordinate values respectively corresponding to a plurality of time points according to satellite signals; and a processing module, coupled to the GPS module, for controlling operations of the PND. The processing module is capable of integrating the plurality of sets of coordinate values respectively corresponding to the plurality of time points and other information into integrated information complying with a Markup Language (ML), and is capable of controlling the PND to output the integrated information. The processing module further includes a data editing unit for editing the integrated information.

### BACKGROUND OF THE INVENTION

1. Field of the Invention

The invention relates to a Global Positioning System (GPS) and, more particularly, to a Personal Navigation Device (PND).

2. Description of the Prior Art

The earliest use of the Global Position System (GPS) was appearing in USA military affairs. Today, GPS has been opened up to public for positioning. Consequently, this technology employing the artificial satellite and communication technique has been flourished in civilian market. The typically GPS products not only provide accurate position, but also precisely provide related information, such as speed, time, direction, and distance, by calculation.

With the development of the Internet, various Internet application software and websites have mushroomed. Users may compile the digital photos in tour with the information generated by GPS device, such as time, location, and etc., to an exercisable format of an Internet application software (such as Google Earth) or at least apart of original files of website (such as Google Map, UrMap, and etc.) which having function of citing map website by post processing (for example, compile on a personal computer PC). Therefore, the digital photos can be shown to others (such as friends, relatives, or even ordinary web) together with the time and the locations of the photos taken during the route of the trip, so that they can clearly understand the entire travel schedule.)

Similarly, the workers of the hotels and B&B on scenic spots also can show the way to the scenic spots together with the corresponding digital photos to tourists by the post processing mentioned above for avoiding lost.

From above, compiling the digital photos together with information generated by GPS device, such as time, location, and etc., to an executable format of an Internet application software or at least apart of original files of website having function of quoting map website has been request of many users. However, the post processing will expend quite a lot of time and labor.

### SUMMARY OF THE INVENTION

The objective of the invention is providing a personal navigation device (PND) for solving the problems stated above.

An embodiment of the invention provides a PND including: a processing module for controlling operations of the PND; a Global Positioning System (GPS) module coupled to the processing module for generating a plurality of sets of coordinate values respectively corresponding to a plurality of time points according to satellite signals; a image taking module coupled to the processing module for taking images; and a user interface module coupled to the processing module for users to input text. The processing module is capable of integrating the plurality of sets of coordinate values respectively corresponding to the plurality of time points, images taken by the image taking module, and texts inputted through the user interface module into integrated information complying with Markup Language (ML), and is capable of controlling the PND to output the integrated information. The processing module further includes a data editing unit for editing the integrated information.

An embodiment of the invention provides a PND including: a GPS module for generating a plurality of sets of coordinate values respectively corresponding to a plurality of time points according to satellite signals, wherein the plurality of sets of coordinate values include a set of current coordinate values; a processing module, coupled to the GPS module, to control operations of the PND and generate direction information according to the set of current coordinate values and a set of specific coordinate values, wherein the set of specific coordinate values can be another set of coordinate values or a set of user defined coordinate values of the plurality of sets of coordinate values; and a user interface module, coupled to the processing module, to output direction information for users. In addition, the processing module is capable of integrating the plurality of sets of coordinate values respectively corresponding to the plurality of time points and the direction information into integrated information complying with ML, and is capable of controlling the PND to output the integrated information. The processing module further includes a data editing unit for editing the integrated information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a Personal Navigation Device (PND) provided by a first embodiment of the invention.

FIG. 2 is a schematic diagram showing a PND provided by a second embodiment of the invention.

FIG. 3 is a schematic diagram showing a PND provided by a third embodiment of the invention.

### DETAILED DESCRIPTION

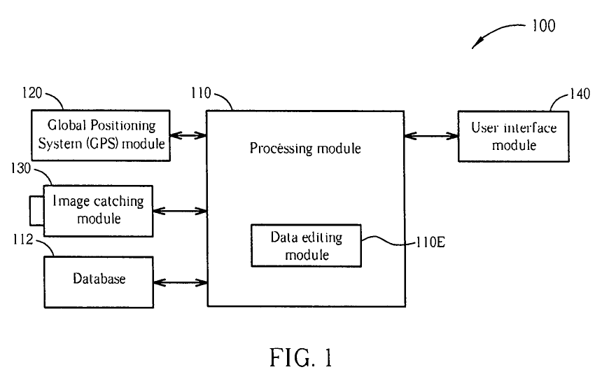

Please refer to FIG. 1. FIG. 1 is a schematic diagram showing a Personal Navigation Device (PND) 100 provided on first embodiment of the invention. The PND 100 is a Personal Digital Assistant (PDA) in the embodiment. The PND 100 includes a processing module 110, a database 112, a Global Positioning System (GPS) module 120, an image taking module 130, and a user interface module 140.

The processing module 110 is for controlling the operations of the PND. According to the embodiment, the processing module 110 controls the operations of the PND 100 according to at least one program code, wherein the program code including a firmware code. The processing module 110 further includes a data editing unit 110E for editing data, such as data stored in the database 112. The data editing unit 110E of this embodiment is realized by using the processing module 100 to execute at least one program code, such as a firmware code The GPS module 120 can generate a plurality of sets of coordinate values, such as longitudes, latitudes, and altitudes, corresponding to a plurality of time points according to satellite signals for the processing module 110.

According to the embodiment, users can take images by the image taking module 130 to generate digital photos to record images of every place in a trip. The user interface module 140 of the embodiment provides text input mechanism so that users can input texts to record text information, such as experience on the road or explanations of the passed way. In the embodiment, the user interface module 140 is realized by utilizing a touch screen (not shown) including a touch panel and a liquid crystal display (LCD), wherein the implementation of the touch screen is well known in the same profession and no unnecessary descriptions is given herein.

In the embodiment, the processing module 110 can integrate the plurality of sets of coordinate values respectively corresponding to a plurality of time points, the images taken by the image taking module 130 (digital photos mentioned above), and the texts inputted through the user interface module 140 into integrated information, and can control the PND to output the integrated information. Wherein, the integrated information conforms to a Markup language (ML). For example, when the PND 100 is coupled to a personal computer (PC) (not shown), the processing module 110 is capable of controlling the PND 100 to output the integrated information to the PC.

In the embodiment, the ML is a Keyhole Markup Language (KML) which format can be applied by the Internet application software “Google Earth”. Therefore, users can show the digital photos together with time and location of the tour route together with texts without the post processing mentioned above, in order to clear understand entire travel schedule. Similarly, the workers of the hotels and B&B on scenic spots also can show the way to the scenic spots and corresponding digital photos with text to tourists without the post-processing mentioned above for avoiding lost.

According to the embodiment, the processing module 110 for executing the firmware code can store the integrated information in the database 112 and edit the integrated information by the data editing unit 110E.
According to a variation of the embodiment, the PND further includes a voice receiving module (not shown), such as a microphone, coupled to the processing module to receive sound waves for generating a voice signal. The processing module can generate voice information according to the voice signal, and then integrate the plurality of sets of coordinate values respectively corresponding to a plurality of time points, the images taken by the image taking module, the voice information, and the texts inputted through the user interface module into the integrated information.

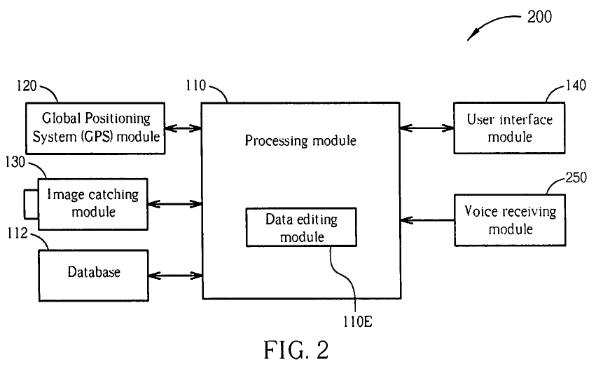

Please refer to FIG. 2. FIG. 2 is a schematic diagram showing a PND 200 according to a second embodiment of the invention. The second embodiment is a variation of the first embodiment, and the difference is the PND 200 further including a voice receiving module 250 (such as a microphone) for receiving sound wave to generate a voice signal. In addition, the firmware code is modified to expand functions, so that the processing unit 110 of this embodiment can generate voice information according to the voice signal, and integrate the plurality of sets of coordinate values respectively corresponding to a plurality of time points, the images taken by the image taking module 130 (digital photos mentioned above), the voice information, and the texts inputted through the user interface module 140 into integrated information partially complying with a ML, and can control the PND 200 to output the integrated information. Wherein, the ML of the embodiment is Hypertext Markup Language (HTML), and the integrated information of the embodiment is partially complying with the HTML and partially complying with JavaScript (JS). For example, when the PND 200 (herein is a PDA) is coupled to the PC, the processing module 110 is capable of controlling the PND 200 to output the integrated information to the PC.

In the embodiment, the integrated information can be at least part of the original files of the website with function of citing map website (such as citing “Google Map”, “UrMap”, and etc.). Therefore, users can show the digital photos together with texts and voice information together with time and location of the tour route without (without + Ving or noun) the post-processing mentioned above, in order to clearly understand the entire travel schedule. Similarly, the workers of the hotels and B&B on scenic spots also can show the way to the scenic spots and corresponding digital photos with text and voice information to tourists without the post-processing mentioned above for avoiding lost.

The data editing unit 110E of this embodiment is realized by using the processing module 100 to execute at least one program code, such as the modified firmware code.) According to the embodiment, the processing module 110 for executing the modified firmware code can store the integrated information in the database 112 and edit the integrated information by the data editing unit 110E.

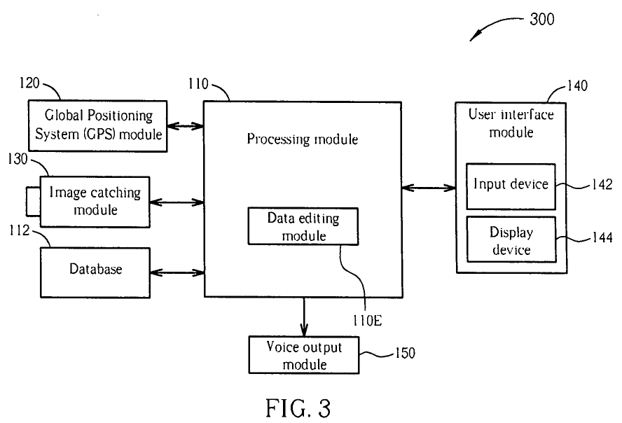

Please refer to FIG. 3. FIG. 3 is a schematic diagram showing a PND 300 of an embodiment of the invention. The third embodiment is a variation of the first embodiment, and the difference is the firmware code being replaced by another firmware code. According to FIG. 3, the plurality of sets of coordinate values include a set of current coordinate values, and the processing module 110 for executing the other firmware code generates direction information according to the set of current coordinate values and a set of specific coordinate values, wherein the set of specific coordinate values can be another set of coordinate values or a set of user defined coordinate values of the plurality of sets of coordinate values. The user interface module 140 is to output direction information to users for reference.

In the embodiment, the users interface module 140 includes an input device 142 (the touch panel) for inputting the set of user defined coordinate value, and a display device 144 (the LCD) for displaying the direction information. The processing module 110 for executing the other firmware code is able to control the LCD to display a compass to show the direction information for suggesting directions to users. Furthermore, the processing module 110 for executing the other firmware code also can generate tracking information corresponding to the plurality sets of coordinate values and control the display device 144 to display the tracking information for suggesting directions.

The processing module 110 for executing the other firmware code can integrate the plurality of sets of coordinate values respectively corresponding to a plurality of time points and the direction information into integrated information complying with an ML, and can control the PND 300 to output the integrated information. The data editing unit 110E of this embodiment is realized by using the processing module 1 00 to execute at least one program code, such as the other firmware code According to the embodiment, the processing module 110 for executing the other firmware code can store the integrated information in the database 112 and edit the integrated information by the data editing unit 110E.

The ML of the embodiment can be the KML, and the HTML, wherein the integrated information is partially complying with the HTML and partially complying with the JS.

According to a variation of the embodiment, the PND further includes a voice output module 150 as shown in FIG. 3, such as a loudspeaker, to play at least one voice message as the direction information.

Those skilled in the art will readily observe that numerous modifications and alterations of the device and method may be made while retaining the teachings of the invention.

What is claimed is:

1. A personal navigation device (PND) comprising:
a processing module for controlling operations of the PND;
a Global Positioning System (GPS) module coupled to the processing module for generating a plurality of sets of coordinate values respectively corresponding to a plurality of time points according to satellite signals; and
a user interface module coupled to the processing module for users to input texts;
wherein the processing module integrates the plurality of sets of coordinate values respectively corresponding to a plurality of time points, at least one image, and texts inputted through the user interface module into an integrated information complying with a Markup Language (ML), and controls the PND to output the integrated information;
wherein the processing module further comprises a data editing unit for editing the integrated information.

2. The PND according to claim 1, wherein the PND further comprises a database coupled to the processing module for storing the integrated information.

3. The PND according to claim 1, wherein the PND is a Personal Digital Assistant (PDA).

4. The PND according to claim 1, further comprising a image taking module coupled to the processing module to take the image.

5. The PND according to claim 1, further comprising:
a voice receiving module coupled to the processing module for receiving sound wave to generate a voice signal;
wherein the processing module generates voice information according to the voice signal, and integrates the plurality of sets of coordinate values respectively corresponding to a plurality of time points, the image taken by the image taking module, the voice information, and inputted texts through the user interface module into the integrated information.

6. The PND according to claim 1, wherein the ML is a Keyhole Markup Language (KML).

7. The PND according to claim 1, wherein the ML is a Hypertext Markup Language (HTML), and the integrated information is partially complying with the HTML and partially complying with JavaScript (JS).

8. The PND according to claim 1, wherein the user interface module comprises an input device for inputting information.

9. The PND according to claim 1, wherein the user interface module comprises a display device to display information.

10. The PND according to claim 1, wherein the processing module generates tracking information corresponding to the plurality of sets of coordinate values and the display module displays the tracking information.

11. The PND according to claim 1, further comprising a voice output module for playing at least one voice message as direction information.
